(19) United States
(12) Patent Application Publication
(10) Pub. No.: US 2025/0223072 A1
(43) Pub. Date: Jul. 10, 2025

(54) PRESSING ELEMENT FOR PRESSING LABELS ONTO BOTTLES, AND METHOD FOR PRODUCING SAID PRESSING ELEMENT

(71) Applicant: Krones AG, Neutraubling (DE)

(72) Inventors: Luca VOELKL, Hackenberg (DE); Thomas HARTWICH, Steinberg am See (DE); Andreas REISINGER, Wald (DE)

(21) Appl. No.: 18/850,549

(22) PCT Filed: Feb. 10, 2023
(86) PCT No.: PCT/EP2023/053315

§ 371 Date: Sep. 24, 2024

(30) Foreign Application Priority Data
Mar. 29, 2022 (DE) 10 2022 107 313.0

(51) Int. Cl. B65C 9/36; B33Y 10/00; B33Y 80/00; B65C 3/08

(52) U.S. Cl. CPC B65C 9/36; B65C 3/08; B33Y 10/00; B33Y 80/00

(57) ABSTRACT

A pressing element for pressing labels onto bottles and a method for producing the pressing element are described. The pressing element comprises a front-face pressing pad with a pressing contour for pressing the labels against the surface of wall sections and a rear-face securing section for fastening the pressing element to an associated actuation arm. The region of the pressing contour is designed to be elastically deformable with respect to the securing section.

### RELATED APPLICATIONS

This application claims the benefit of International Application No. PCT/EP2023/053315, filed Feb. 10, 2023, which claims priority to German Application No. DE102022107313.0, filed Mar. 29, 2022. The entire contents of both applications are hereby incorporated by reference.

### TECHNICAL FIELD

The present disclosure relates to a pressing element for pressing labels onto bottles, and to a method for producing the pressing element.

### BACKGROUND

Pressing elements are used to press neck labels or the like, for example security labels, onto the surfaces of bottles after they have been applied. For this purpose, the pressing elements together with the bottles to be labeled rotate on a container carousel of a labeling machine and are pressed onto the assigned labels, for example by means of a pivoting lever, after the bottle has been positioned in a suitable rotational position. The bottles are clamped upright between a rotating container plate and an associated centering tulip or centering bell.

Such pressing elements are essentially formed as a negative shape of the wall sections to be labeled. Since bottles usually have convex outer cross-sections in the neck region and/or at the mouth end, the corresponding pressing elements have corresponding pressing contours with concave cross-sections. To ensure that the labels are pressed as completely as possible over the entire surface, the region of the pressing contour is also designed to be elastically flexible. The pressing element can therefore also be understood as a pressing pad in the region of the pressing contour, which is made for example of a silicone or similar elastic material.

In order to fasten the pressing element to the associated actuation arm, for example a swivel arm, the pressing element comprises a fastening plate on its rear side opposite the pressing contour, which plate can preferably be fastened to the actuation arm with a positive fit, for example by means of a screwed connection. The pressing pad is then screwed to the fastening plate in the same way, which requires threaded plates to be integrated into the pressing pad during production, for example during a casting process.

The problem with the known pressing elements is that the pressing pads are made, for example from silicone, by casting, which requires negative molds, and threaded plates or similar fastening elements have to be inserted during casting, which is comparatively complex. This is all the more complex because different container formats may need to be labeled, which requires not only separate pressing elements, but also the associated molds and auxiliary equipment for producing the pressing elements. Casting is also comparatively time-consuming and inflexible, since the casting molds have to be ordered in advance and only one pressing element can be produced per mold. Additional storage costs are also incurred for the molds. The known pressing elements and their production thus entail an undesirably high expenditure on materials, storage, and working time for the production and assembly of the pressing elements, especially in view of the increasing flexibility of filling systems and associated labeling processes.

There is therefore a need for improved pressing elements and their production in order to eliminate or at least mitigate at least one of the problems mentioned above.

### SUMMARY

Embodiments of the present disclosure provide a pressing element comprising a pressing pad with a front-face pressing contour configured to press labels onto a surface of wall sections of the bottles, and a rear-face securing section configured to fasten the pressing element to an associated actuation arm, wherein a region of the pressing contour is elastically flexible with respect to the securing section, wherein the pressing pad and the securing section are integrally formed together and are made of at least one additively layered material, and wherein elastically deformable cavities are formed in the pressing pad. Embodiments further provide a method for producing the pressing element.

### BRIEF DESCRIPTION OF THE DRAWINGS

Preferred embodiments of the invention are illustrated in the drawing. In the figures:

FIGS. 1A to 1E show a preferred embodiment of the pressing element with associated holding plate;

FIG. 2 shows a section through a pressing element according to a second embodiment;

FIG. 3 shows a pressing element according to a third embodiment;

FIG. 4 shows a schematic representation of the arrangement of the pressing element on a labeling machine; and

FIG. 5 shows a schematic diagram of one embodiment of the production method.

### DETAILED DESCRIPTION

The pressing element of embodiments is suitable for pressing labels onto bottles in a labeling machine. For this purpose, the pressing element comprises a pressing pad with a front-face pressing contour for pressing the labels onto in particular the surface of wall sections, in particular neck sections, of the bottles, and a rear-face securing section for fastening the pressing element to an associated actuation arm. The area of the pressing contour is designed to be elastically deformable with respect to the securing section. This means that when labels are pressed on, the area of the pressing contour deforms elastically more than does the securing section, which can therefore be considered rigid in this respect.

According to embodiments of the invention, the pressing pad and the securing section are formed together integrally and are made of at least one additively layered material. Furthermore, elastically deformable cavities can be formed in the pressing pad. This means that both the cavities and the structures surrounding them (which can consist of different material thicknesses) of the pressing pad can be elastically deformed. The cavities thus contribute to the appropriate elastic flexibility of the pressing pad and/or make this possible in the first place.

Additive layering in the sense of the present invention is also referred to as 3D printing or generative layering. This means that the basic design is achieved neither by shaping material in a negative mold nor by removing material.

The proportion by volume, the shape and orientation of individual cavities and of the surrounding walls and/or separating webs can be variably and specifically adapted to the label dimensions and bottle dimensions to be processed by means of the additive manufacturing described.

The cavities of the described pressing element therefore differ from evenly distributed cavities in semi-finished products, such as bubbles in a foam.

In other words, the cavities according to the invention are individually specified and produced on the basis of electronic printing templates for the 3D printing of the walls, webs, and/or similar structures of the pressing pad surrounding them.

In this way, suitably shaped pressing pads and in particular their pressing contours can be produced quickly and cost-effectively in a flexibly adaptable manner and without the aid of casting molds or tools for material removal.

For example, the required elastic flexibility of the pressing pad and the contrasting rigid design of the securing section can be achieved by making the volume proportion of the cavities in the fastening pad greater than in the securing section.

For example, the orientation and number of walls (or wall lines in the case of FDM printing), connecting webs, stiffening ribs or similar structures in the securing section can be specifically adjusted to achieve the required stiffness there.

The surface of the pressing element can, for example, have a honeycomb, nubbed, strip-type and/or otherwise structured surface in the region of the pressing contour. This can promote the pressing of labels without undesirable warping and/or a correspondingly unproblematic withdrawal of the pressed-on pressing element.

In some embodiments, the cavities have a longitudinally elongated shape at least in the region of the pressing contour. This can also be understood as a channel-like course of the cavities, substantially in the longitudinal direction. The cavities therefore have a longer extension in longitudinal sections through the pressing element than in cross-sections through the pressing element. For example, in relation to an upright bottle the longitudinal direction is the vertical direction.

Since the pressing element is guided and pressed against the bottles substantially transversely to the longitudinal direction, the required elastic flexibility of the pressing pad can be produced particularly well above all in the region of its pressing contour by means of cavities running predominantly in the longitudinal direction, even when a relatively stiff material is used. In addition or as an alternative, however, differently shaped and/or oriented cavities can also be created in the pressing pad as described.

At least some of the cavities can have, in particular in the region of the pressing contour, a clear cross-sectional width, defined in the pressing direction, which is at least as large as the thickness of the walls, wall lines, connecting webs or similar structures that are adjacent there. The required flexibility of the pressing contour is created by the elastic deformation of the walls surrounding the cavities. The cavities then offer the surrounding walls sufficient room for movement for elastic deformation of the pressing contour.

In some embodiments, the cavities take up at least half the volume of the pressing pad. This means that even comparatively hard materials can be used to produce the pressing pad.

In some embodiments, the pressing pad comprises, at least in the region of the pressing contour, an outer wall made up of at least two wall lines running alongside one another. This allows the elasticity of the pressing contour to be specifically adapted to the surfaces to be labeled, for example to relief-like uneven areas that can occur at the edge of the label towards the bottle wall, and/or to embossings. The wall lines of interior and/or exterior walls can optionally form double-walled structures, wherein the wall lines running next to each other are then preferably connected at points by connecting webs.

Wall lines are beads of material layered on top of each other which a print head leaves behind in the form of print marks when printing with the corresponding print feed rate. The thickness of such wall lines or material beads is mainly determined by the diameter of the nozzles used and is, for example, between 0.4 and 0.8 mm.

In principle, wall lines can be printed not only at a distance from each other, so that they form a multi-walled and in particular double-walled structure, but also at no distance from each other, thereby creating a wall with a thickness that is essentially a multiple of the respective wall line thickness. Different wall thicknesses/structures can thus be created in a reproducible and flexibly adaptable manner via the number, distance, and thickness of adjacent wall lines, by means of printer programming and nozzle selection.

In some embodiments, the pressing contour has a concavely curved outer cross-section for pressing the labels onto a wall region of the bottles with a convex outer cross-section. This allows the pressing element to be specifically adapted to press neck labels and/or security labels onto a mouth region and/or neck region of bottles.

In some embodiments, the pressing pad is made of a softer material than the securing section. The hardness of the materials is then specified in Shore, for example Shore A. This makes it easier to produce the required elastic flexibility of the pressing pad and the required stiffness in comparison of the securing section.

In some embodiments, the pressing pad is made of thermoplastic polyurethane, in particular TPU95a. This material can be easily processed additively by 3D printing and, in the form of the structures surrounding the described cavities, promotes elastic flexibility of the pressing pad, at least in the region of the pressing contour.

In some embodiments, the securing section is made of PET, carbon-fiber-reinforced PET, for example PET CF15, PLA (polylactide), in particular Tough PLA, and/or TPU95a. These materials are particularly well-suited for 3D printing and make possible on the one hand the required stiffness of the securing section and on the other hand an additive material fusion with the material of the pressing pad, especially TPU95a. In this way, relatively dense filling structures and/or support structures can be specifically formed in the securing section.

In some embodiments, the securing section comprises a fastening rail running in the longitudinal direction of the pressing contour. This means that the securing section can, for example, be inserted into an associated retaining rail of a holding plate and thus be positively fastened to an associated actuation arm. As a rule, no significant pressure forces need to be transmitted in the longitudinal direction. This makes an easy insertion possible and at the same time a sturdy positive fit in the transverse direction in order to dissipate pressure forces. This also eliminates the need for a laborious screwing tight of the pressing element.

The described method serves to produce the pressing element according to at least one of its described embodiments. In the method, the pressing pad and the securing section are built up together additively in layers by means of 3D printing. The advantages described herein can thus be achieved.

In some embodiments, the pressing pad made of a first material and the securing section made of a second material are printed onto one another in layers, preferably with overlapping, while being materially bonded to one another by material fusion. That is to say, the first material, for example from a first print head, and the second material from a second print head are printed together, for example crossed over one another, in an uncured state such that the first and second materials can bond together to form an overall one-piece structure of the securing section and the pressing pad.

For example, the different materials can be printed onto each other (e.g. crossed) and fused together by alternately using print heads assigned to each, on the basis of corresponding programming of a 3D printer.

The additive process (3D printing) described is preferably FDM printing (fused deposition modeling). Another preferred method is 3D powder printing.

In some embodiments, the pressing pad is built up in layers from thermoplastic polyurethane, in particular TPU95a.

The securing section is then built up in layers from PET, carbon-fiber-reinforced PET, for example PET CF15, PLA, for example Tough PLA, and/or TPU95a.

The materials mentioned are particularly suitable for additive material fusion with one another in 3D printing. Consequently, the pressing pad and the securing section and thus the pressing element as a whole can be produced in one piece by additive layer-by-layer construction, if necessary from at least two different materials.

The cavities are individually specified as design data in an electronic printing template, for example. The 3D printing is then carried out on the basis of the printing template, wherein the cavities are formed by being left out in the material application of the print layers.

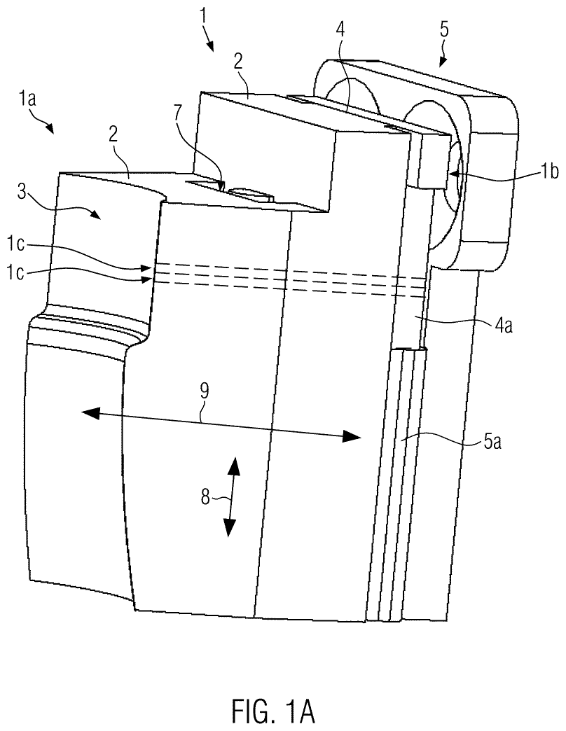

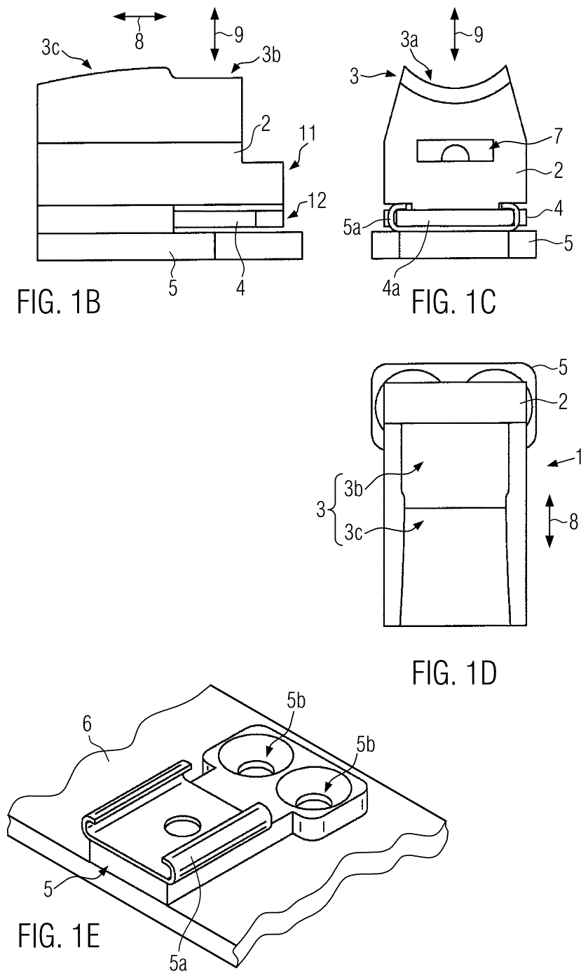

Referring now to the figures, as can be seen from FIGS. 1A to 1E, the pressing element 1 comprises a pressing pad 2 with a pressing contour 3 formed on the front face 1a of the pressing element 1. Furthermore, the pressing element 1 comprises on its rear face 1b a securing section 4 for fastening the pressing element 1 to a holding plate 5, which can be fastened to an actuating element, such as an actuation arm 6, for pressing on the pressing contour 3, or can be integrated into such an actuating element.

The pressing pad 2 is designed to be elastically flexible with respect to the securing section 4, so that the pressing pad 2 can deform when the pressing contour 3 is pressed. The securing section 4, on the other hand, is rigid and therefore deforms less, and preferably essentially not at all, during the pressing.

Deformable cavities 7 are formed in the pressing pad 2, which preferably have an elongated shape in the longitudinal direction 8 at least in the region of the pressing contour 3, and are then formed for example as channels running substantially in the longitudinal direction 8. This means that the dimensions of such elongated cavities 7 are larger in the longitudinal direction 8 (from top to bottom or vice versa) than in a pressing direction 9 orthogonal thereto (from back to front).

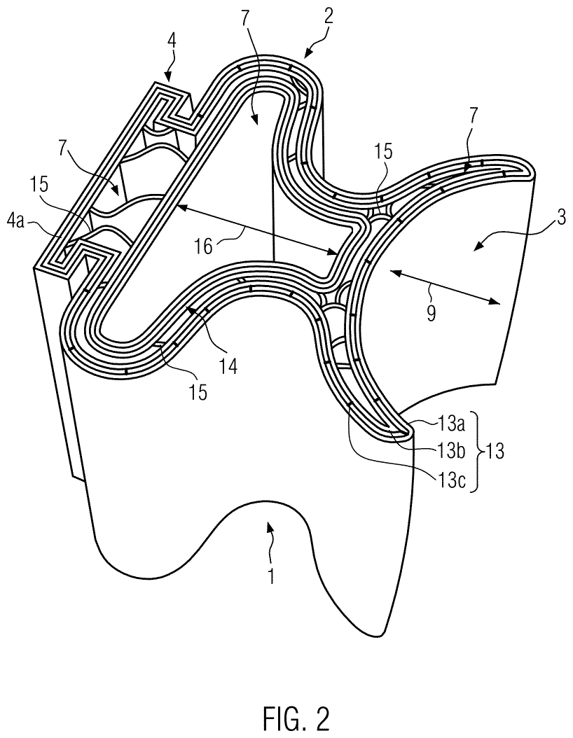

In the external views in FIGS. 1A to 1E, only one cavity 7 running from top to bottom can be seen. Further cavities 7, in particular elongated/channel-like, are formed at least in the interior of the pressing pad 2 but can also be present in the securing section 4, which can be seen by way of example in FIG. 2.

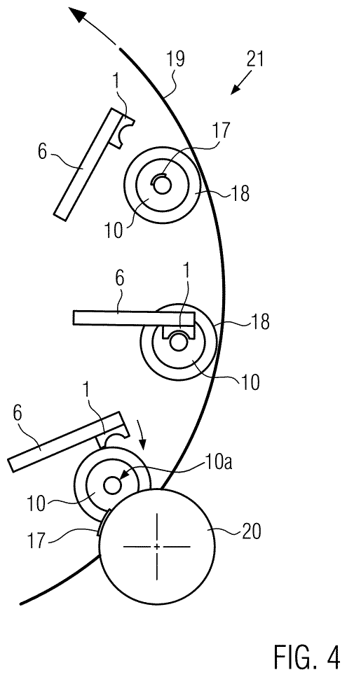

The cavities 7 bring about an elastic flexibility of the pressing pad 2, in particular in the pressing direction 9. The flexibility promotes the pressing of the pressing contour 3 over as full a surface as possible on an associated bottle 10 (see FIG. 4) or similar container.

FIGS. 1A to 1E further show that the securing section 4 preferably comprises at least one fastening rail 4a extending in the longitudinal direction 8, which works together in a positive-fitting manner with a holding rail 5a formed on the holding plate 5.

The pressing element 1 is then fastened to the holding plate 5 by sliding the fastening rail 4a and the holding rail 5a into one another in the longitudinal direction 7. The pressing element 1 can thus be easily and quickly fastened to the holding plate 5 and to the associated actuation arm 6 as a set-up part. At the same time, this positively fitting connection makes possible sufficient lateral stability for transmitting pressing forces in the pressing direction 9 from the actuation arm 6 onto an associated bottle 10 by means of the pressing element 1.

As can be seen, for example, in FIG. 1C, the pressing contour 3 has a preferably concavely curved outer cross-section 3a. In the present example, the pressing contour 3 also has an upper contour section 3b, which is adapted, for example, to a closure area and/or a mouth region of the bottles 10 to be labeled, and a lower contour section 3c, which is adapted, for example, to a neck region of the bottles 10 to be labeled. However, the pressing contour 3 could also be adapted to the shoulder and/or body regions of the bottles 10. Likewise, at least two pressing elements 1 for different wall sections 10a (FIG. 4) of the bottles 10 could be grouped one above the other.

In FIG. 1A, it is schematically indicated that the one-piece pressing element 1 is made up of printed layers 1c which are additively arranged on top of one another by means of 3D printing and which in each case extend not only over both the pressing pad 2 but also over the securing section 4.

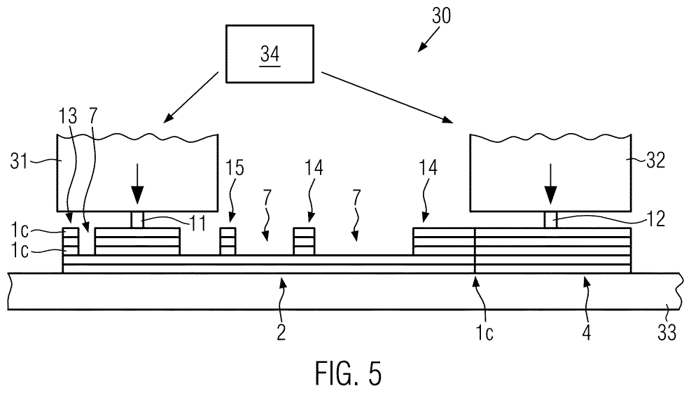

As schematically indicated in FIG. 1B, for example, the pressing pad 2 can consist of or comprise a first material 11 and the securing section 4 of a preferably harder second material 12. The first and second materials 11, 12 are suitable for 3D printing in such a way that the first and second materials 11, 12 can be printed onto each other, preferably crossed over one another, while fusing together in a materially bonding manner; see also FIG. 5. Such material fusion (fused deposition modeling) is the basis for the one-piece formation of the pressing element 1, provided that it is made of at least two different materials 11, 12. In principle, however, it would also be conceivable to build up the pressing pad 2 and the securing section 4 additively in layers from the same material, for example from the first material 11.

The first material 11 is, for example, thermoplastic polyurethane, in particular TPU95a. This material has a Shore A hardness of 95. Despite the relatively high hardness of this material, the described cavities 7 make possible a suitable elastic flexibility of the pressing pad 2, particularly in the region of the pressing contour 3.

The second material 12 is, for example, PET, carbon-fiber-reinforced PET, PLA, or also a thermoplastic polyurethane, in particular TPU95a.

The pressing pad 2 and the securing section 4 can in principle also be made from the same material 11 in 3D printing, for example from TPU95a. The different flexibility/stiffness of the pressing pad 2 and the securing section 4 then essentially results only from the arrangement of the cavities 7 and filling structure.

The surface of the pressing element 1 can, for example, have a honeycomb, nubbed, strip-type and/or otherwise structured, for example relief-type, surface in the region of the pressing contour 3.

Likewise, the surface of the pressing contour 3 can consist of a non-stick material (not shown) which adheres less well to the label 17 to be pressed (FIG. 4) than does the first material 11. That is to say, the first material 11 and the cavities 7 surrounded thereby can then substantially determine the stiffness/flexibility of the pressing pad 2, whereas the non-stick material would determine the adhesive properties of the pressing contour 3 with respect to the label 17. The non-stick material could be understood as a coating of the pressing contour 3, for example for facilitating the detachment of the pressed- on pressing element 1 from the label 17. The non-stick material is then preferably also applied by 3D printing.

As can be seen from FIG. 1E, the holding plate 5 is detachably fastened to the associated actuation arm 6, for example by means of screwed connections 5b. The holding plate 5 could however also be integrated into the actuation arm 6.

The described pressing element 1 is a format-specific set-up part, which can therefore be inserted into the holding plate 5 depending on the label dimensions and bottle dimensions. This plate, on the other hand, is a non-format-specific connecting element for fastening different pressing elements 1 to the actuation arm 6.

Pressing elements 1 for different label and bottle formats differ from one another in the region of the pressing contour 3 and if appropriate by the formation of different cavities 7. In contrast, the securing section 4 is preferably designed uniformly, at least in the region of the fastening rail 4a, in order to be able to fasten different pressing elements 1 to one and the same holding plate 5.

In principle, however, other positive-locking connections of the pressing element 1 to the holding plate 5 and/or to the actuating arm 6 would also be conceivable, for example screwed connections. For this purpose, for example internal threads could be made in the securing section 4 by means of 3D printing, in order to screw the pressing element 1 there to the associated holding plate 5 and/or to the associated actuation arm 6. However, the illustrated embodiments of the pressing element 1 with fastening rails 4a make possible a particularly simple and rapid positive-fit fastening of the pressing element 1.

While FIGS. 1A to 1D show the pressing element 1 only from the outside, FIG. 2 also shows the internal structure of the pressing element 1 with a large number of the described cavities 7 or filling structure, on the basis of a further embodiment.

Accordingly, for example, the outer wall 13 of the pressing element 1 can be double-walled (made up of two wall lines) at least in the region of the pressing pad 2 and in particular in the region of its pressing contour 3. Accordingly, the outer wall 13 there consists of an outer wall or wall line 13a, an inner wall or wall line 13b, and connecting webs 13c formed therebetween, in each case enclosing channel-like cavities 7. In a corresponding manner, at least one inner wall 14 of the pressing pad 2 could be double-walled and/or consist of at least two wall lines.

However, wall lines (in the sense of material beads layered on top of each other during 3D printing), for example the outer and inner wall lines 13a, 13b, can also be printed on one another without cavities 7 and connecting webs 13c in between in order to produce a desired wall thickness, here for example of the outer wall 13.

Furthermore, connecting webs 15 can be formed, for example, between an outer wall 13 and an inner wall 14 and/or between a plurality of inner walls 14. As a result, elongated/channel-like cavities 7 are formed that preferably run substantially in the longitudinal direction 8.

At least some of the cavities 7 preferably have a maximum clear width 16 measured in the pressing direction 9 (in each case a maximum clear width of a cavity 7 as viewed from the rear side 1b to the front side 1a) which is greater than the thickness of the walls adjacent there (in FIG. 2, for example, the thickness of the adjacent inner walls or wall lines of the double-walled inner wall 14).

Cavities 7 running substantially in the longitudinal direction 8 promote an elastic flexibility of the pressing pad 2 in the pressing direction 9 and nonetheless allow sufficient stability and stiffness to transfer suitable pressing forces by means of the pressing contour 3 onto the bottles 10 or the labels 17 attached thereon (see FIG. 4).

The described 3D printing makes possible a flexible design of outer walls 13, inner walls 14 and/or connecting webs 15, as well as of the cavities 7 enclosed thereby, not only from a uniform material 11 for the pressing pad 2 and the securing section 4 but also from different materials, such as from the described first and second materials 11, 12. This can be achieved, for example, by suitable programming of the 3D printer 30 used and by using separate print heads 31, 32 to extrude the materials 11, 12 (see FIG. 5).

Due to their individual design in accordance with an electronic printing template 34 (FIG. 5) the described cavities 7 differ fundamentally from a homogeneous structure of foams or similar semi-finished products with cavities specified by the supplier. In other words, the size, shape, and position of the individual cavities 7 are specifically specified in a printing template 34 during construction and are specifically produced by corresponding 3D printing of the surrounding outer walls 13, inner walls 14, and/or connecting webs 15 in each case.

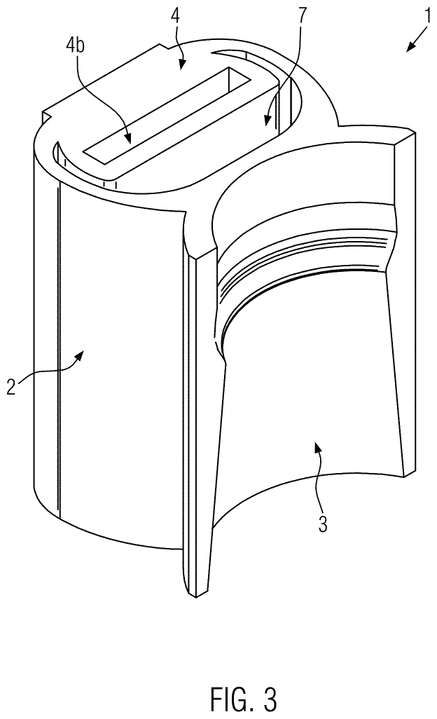

FIG. 3 shows an alternative embodiment of the pressing element 1, in which the securing section 4 has a fastening channel 4b running in the longitudinal direction 8, which is pushed, for example, over a corresponding holding rail of a holding plate or of an actuation arm (in each case not shown) in order to make possible a positive-fit fastening of the pressing element 1 to an actuation arm, substantially having the advantages described above. Otherwise, the pressing element 1 according to FIG. 3 can have features described with reference to the other embodiments of the pressing element 1, for which corresponding reference signs have been used.

FIG. 4 shows, in a schematic plan view, the arrangement of the pressing elements 1 on associated actuation arms 6 and their mode of operation in the region of turntables 18 on which the bottles 10 are clamped in an upright position, for example by means of centering tulips/centering bells (not shown). Accordingly, the container plates 18 and the associated actuation arms 6 rotate together on a container carousel 19 in order to furnish the bottles 10 clamped thereon with labels 17. These are transferred, for example by means of a transfer cylinder 20, to wall sections 10a of the bottles 10 in a known manner.

The labels 17 thus applied to the bottles 10 are full-area fastened during further circulation on the container carousel 19 by pressure of the pressing elements 1 on the labels 17. For this purpose, the labels 17 are positioned by means of the turntables 18 in a suitable rotational position in the working area of the pressing elements 1 in a known manner.

The container carousel 19 with the turntables 18, the actuation arms 6 and the pressing elements 1 attached to it in the sense of set-up parts are, like the transfer cylinder 20, preferably components of a rotary-type labeling machine 21. Its manner of operation is known in principle and is therefore not explained in detail here. Of course, the pressing element 1 could also be used in a corresponding manner in stationary labeling stations (not shown).

FIG. 5 schematically illustrates the layer-by-layer additive structure of the described pressing element 1 in 3D printing.

Accordingly, the print layers 1c, which in each case extend not only over the pressing pad 2 but also over the securing section 4, are successively printed on top of one another by a 3D printer 30.

In the example, the pressing pad 2 is printed from a first material 11 using a first print head 31 and the securing section 4 is printed from a second material 12 by means of a second print head 32. The 3D printing of the individual print layers 1c is carried out in such a way that the first material 11 and the second material 12 are printed/extruded onto one another in such a way that they fuse together in a transition region 1d, preferably in an overlapping materially bonded manner. Relative movements required for this can be performed by the print heads 31, 32 in a horizontal plane, for example, and by a build platform 33 supporting the resulting pressing element 1 in a vertical plane, for example, in a manner known in principle.

The described material fusion results in a one-piece construction of the pressing element 1 even when different materials 11, 12 are used for the pressing pad 2 and the securing section 4. The solidification of the print layers 1c is then possible in a manner known in principle.

For the described 3D printing, electronic printing templates 34 are used in which the size, shape, and position of the individual cavities 7 are already specified as design data. This is in contrast to a substantially uniform distribution of cavities in porous semi-finished products. This means that the cavities 7 are deliberately formed during the 3D printing by leaving them out of the material application of the individual print layers 1c. This is indicated in FIG. 5, schematically and by way of example, for cavities 7 that are additively created between an outer wall 13, a connecting web 15 and inner walls 14.

The described method thus makes possible a particularly simple production of pressing elements 1 by programming the 3D printer 30 used on the basis of electronic printing templates 34, eliminating the time expenditure, cost expenditure, and storage expenditure for casting molds and/or special tools for production and assembly compared to conventional pressing elements. This makes it possible to flexibly adapt the pressing elements 1 to different label and container dimensions, if necessary on site, i.e. without the aid of specially equipped workshops, with the aid of 3D printers.

1. A pressing element for pressing labels onto bottles in a labeling machine, comprising:
a pressing pad comprising a front-face pressing contour configured to press the labels onto a surface of wall sections of the bottles; and
a rear-face securing section configured to fasten the pressing element to an associated actuation arm,
wherein a region of the pressing contour is elastically flexible with respect to the securing section,
wherein the pressing pad and the securing section are integrally formed together and are made of at least one additively layered material, and
wherein elastically deformable cavities are formed in the pressing pad.

2. The pressing element according to claim 1, wherein a plurality of the elastically deformable cavities have an elongated shape in a longitudinal direction.

3. The pressing element according to claim 1, wherein a plurality of the elastically deformable cavities have a clear cross-sectional width in a pressing direction which is at least as large as a thickness of walls, wall lines, and/or adjacent connecting webs.

4. The pressing element according to claim 1, wherein the elastically deformable cavities occupy at least half a volume of the pressing pad.

5. The pressing element according to claim 1, wherein the pressing pad is formed, at least in the region of the pressing contour, towards an outside with at least two wall lines running next to one another.

6. The pressing element according to claim 1, wherein the pressing contour has a concavely curved outer cross-section for pressing the labels onto a wall section of the bottles with a convex outer cross-section.

7. The pressing element according to claim 1, wherein the pressing pad is made of a softer material than the securing section.

8. The pressing element according to claim 1, wherein the pressing pad is made of thermoplastic polyurethane.

9. The pressing element according to claim 1, wherein the securing section is made of PET, carbon-fiber-reinforced PET, PLA and/or TPU95a.

10. The pressing element according to claim 1, wherein the securing section comprises a fastening rail running in a longitudinal direction of the pressing contour.

11. A method for producing a pressing element, comprising:
additively constructing the pressing element by printing print layers onto one another using three-dimensional (3D) printing, each of which extends over a pressing pad and over a securing section,
wherein the pressing element comprises a pressing pad with a front-face pressing contour configured to press labels onto a surface of wall sections of bottles.
wherein the pressing element further comprises a rear-face securing section configured to fasten the pressing element to an associated actuation arm.
wherein a region of the pressing contour is elastically flexible with respect to the securing section,
wherein the pressing pad and the securing section are integrally formed together and are made of at least one additively layered material, and
wherein elastically deformable cavities are formed in the pressing pad.

12. The method according to claim 11, wherein the pressing pad is made of a first material and the securing section is made of a second material [[(12)]], and wherein the pressing pad and the securing section are printed onto one another in layers, while being materially bonded to one another by material fusion.

13. The method according to claim 11, wherein the elastically deformable cavities are individually specified as design data in an electronic printing template and the 3D printing is carried out based on the printing template.

14. The method according to claim 11, wherein the elastically deformable cavities are formed during the 3D printing by being left out in a material application of the print layers.

15. The pressing element according to claim 1, wherein the front-face pressing contour is configured to press the labels onto neck regions of the bottles.

16. The pressing element according to claim 2, wherein the plurality of the elastically deformable cavities that have the elongated shape in the longitudinal direction are in the region of the pressing contour.

17. The pressing element according to claim 3, wherein the plurality of the elastically deformable cavities that have the clear cross-sectional width in the pressing direction which is at least as large as the thickness of the walls, the wall lines, and/or the adjacent connecting webs are in the region of the pressing.

18. The method according to claim 12, wherein the layers are overlapping.

19. The method according to claim 11, wherein:
the elastically deformable cavities occupy at least half a volume of the pressing pad; and
a plurality of the elastically deformable cavities have at least one of a) an elongated shape in a longitudinal direction or b) a clear cross-sectional width in a pressing direction which is at least as large as a thickness of walls,-wall lines, and/or adjacent connecting webs.

20. The method according to claim 11, wherein the pressing pad is formed, at least in the region of the pressing contour, towards an outside with at least two wall lines running next to one another.
